(19) United States
(12) Patent Application Publication
(10) Pub. No.: US 2007/0001906 A1
(43) Pub. Date: Jan. 4, 2007

(54) Switchable multiband antenna for the high-frequency and microwave range

(76) Inventors: Heiko Pelzer, Erkelenz (GB); Achim Hilgers, Alsdorf (DE)

Correspondence Address: PHILIPS INTELLECTUAL PROPERTY & STANDARDS, P.O. BOX 3001, BRIARCLIFF MANOR, NY, 10510, US

(21) Appl. No.: 10/556,448

(22) PCT Filed: May 5, 2004
(86) PCT No.: PCT/IB04/50594

§ 371 Date: Nov. 10, 2005

(30) Foreign Application Priority Data
May 16, 2003 (EP) 031013766

(51) Int. Cl. H01Q 1/38

(52) U.S. Cl. 343/700 MS; 343/702

(57) ABSTRACT

A description is given of a switchable multiband antenna for the highfrequency and microwave range, which can be operated in a relatively large number of frequency bands without significant restriction of performance in each individual frequency band. This is essentially achieved by a switchable input structure (24) by means of which resonant printed line structures (21; 22) of the antenna that are not required can be isolated from an HF or ground supply line (242). In particular, in one embodiment, a number of resonant printed line structures are applied to a substrate (10), which printed line structures are connected to the corresponding HF or ground supply line or isolated from the latter, in a targeted manner, by means of one or more switching devices.

The invention relates to a switchable multiband antenna for the high-frequency and microwave range, which can be operated in at least two frequency bands. The invention also relates to a telecommunications device comprising such an antenna.

In general, electromagnetic waves in the high-frequency or microwave range are used to transmit information by means of in particular mobile telecommunications devices. In order to transmit and receive these waves, there is an increasing need for antennas which can be operated in a number of frequency bands in each case with a sufficiently great bandwidth.

In the mobile telephone standard, for example, such frequency bands lie between 880 and 960 MHz (GSM900), between 1710 and 1880 MHz (GSM- or DSC1800), and in particular in the USA between 824 and 894 MHz (AMPS) and 1850 and 1990 MHz (D-AMPS, PCS or GSM1900). Moreover, these include the UMTS band (1880 to 2200 MHz), in particular wide-band CDMA (1920 to 1980 MHz and 2110 to 2170 MHz) and the DECT standard for cordless telephones in the frequency band of 1880 to 1900 MHz and the Bluetooth standard (BT) in the frequency band of 2400 to 2483.5 MHz, which is used to exchange data between various electronic devices such as, for example, mobile telephones, computers, electronic entertainment equipment, etc.

There is also a need, at least during a transition time period, for it to be possible for mobile telephones to be operated both in at least one of the GSM frequency ranges and in the UMTS frequency range.

One requirement is often that of it being possible for a mobile telephone to operate both in the two European (GSM) bands and in the two US bands (AMPS and PCS), so that a user who frequently travels in Europe and the USA does not have to carry two mobile telephones.

Besides transmitting information, mobile telecommunications devices sometimes also have additional functions and applications such as, for example, for the purpose of satellite navigation in the known GPS frequency range in which the antenna should then also operate.

In principle, there is therefore a need for modem telecommunications devices of this type to be able to operate in as many of the aforementioned frequency ranges as possible, so that appropriate multiband antennas are required which cover these frequency ranges.

With the increasing integration of these and other functions in mobile telephones and the simultaneous desire to make the latter as small as possible, the problem furthermore arises that there is less and less space available in the casings, so that the antennas should also be as small as possible in terms of volume and dimensions.

The antennas irradiate electromagnetic energy to form an electromagnetic resonance. This requires that the length of the antenna is at least equal to a quarter of the wavelength of the transmitted radiation. Using air as the dielectric (εᵣ=1), a frequency of 1 GHz accordingly requires an antenna length of 75 mm. This length can be reduced, for example, by winding the antenna wire in the form of a helix, as is usually the case in so-called “stub antennas”.

In order to minimize the size of the antenna at a given wavelength of the transmitted radiation, a dielectric having a dielectric constant εᵣ>1 can be used as basic building block for the antenna. This leads to the wavelength of the radiation in the dielectric being shortened by a factor 1/\sqrt{εᵣ}. An antenna designed on the basis of such a dielectric is therefore also smaller, in terms of its size, by this factor.

An antenna of this type has a substrate made of a dielectric material, on the surfaces of which there are applied, depending on the desired operating frequency band or bands, one or more resonant metallization structures. The values of the resonant frequencies are dependent on the dimensions of the printed metallization structures and on the value of the dielectric constant of the substrate. The values of the individual resonant frequencies decrease as the length of the metallization structures increases and also as the values of the dielectric constant increase. Such antennas are also referred to as “Printed Wire Antennas” (PWAs) or “Dielectric Block Antennas” (DBAs).

One particular advantage of these antennas is that they can be applied directly to a printed circuit board (PCB) by surface mounting (SMD technique), that is to say by flat soldering and contacting—possibly together with other components—without additional mounting devices (pins) being required in order to supply electromagnetic power.

However, the dimensioning of the metallization structures may be problematic and difficult particularly if such an antenna is to operate in a number of frequency bands. This is because optimal adaptation of the antenna to one of the necessary frequency bands means that the antenna powers in the other frequency bands are impaired since the metallization structures mutually affect one another.

From WO 01/29927 A1, a switchable antenna is known in which at least two contact points at a distance from one another are provided on a conductor structure, via which contact points the conductor structure can be optionally connected to a high-frequency feed (or a ground connection). By switching between the two contact points, the effective length of the conductor structure and hence also the resonant frequency are changed, so that, given a suitable distance between the contact points, the antenna can be operated in at least two adjacent frequency bands. The conductor structure is in this case designed either as a patch structure or as a printed line that runs in a meandering manner, with a bar-shaped part-structure arranged on the rear side of a printed line support.

Another type of antenna, which is likewise used in mobile telecommunications devices, is the “Planar Inverted F Antenna” (PIFA) in which a metallization structure is arranged above a ground metallization, said antenna operating as a volume resonator. Although it is known, for example from WO 01/91234 A1, WO 01/91235 A1 and WO 01/91236 A1, to produce a multiband capability also in the case of these antennas by connecting or isolating metallization sections, a disadvantage of these antennas is that they require a relatively large amount of space which can be reduced only to a limited extent, even by using dielectric materials.

It is therefore an object of the invention to provide a switchable antenna of the type mentioned above, which is composed in a relatively simple manner from one or more printed lines but at the same time can be operated in a number of frequency bands of the type mentioned above, which can be tuned and optimized at least largely independently of one another and without feedback.

Furthermore, it is an object of the invention to provide a switchable antenna of the type mentioned above which with as small a size as possible and thus in a space-saving manner can be accommodated in a relatively small mobile telecommunications device.

This object is achieved as claimed in claim 1 by a switchable multiband antenna for the high-frequency and microwave range, comprising at least one resonant printed line structure which is applied to a substrate, and comprising a switchable input structure and at least one line section that is arranged on a support of the substrate, wherein the switchable input structure is provided to connect at least one HF line or at least one ground line to the resonant printed line structure by optional interconnection or bridging of the at least one line section by switching the input structure.

The object is furthermore achieved as claimed in claim 2 by a switchable multiband antenna for the high-frequency and microwave range, comprising at least two resonant printed line structures which are applied to a substrate, and comprising a switchable input structure for the optional connection of an HF line or a ground line to at least one of the resonant printed line structures.

One particular advantage of these solutions is that the abovementioned advantageous properties of DBA antennas, in particular with regard to their simple production and mounting thereof on a printed circuit board, are retained. Since the switchable input structures can be produced on the support of the substrate, already existing antennas can also be retrofitted to become switchable antennas of the type mentioned above, with a relatively low outlay and with no, or only a few, changes.

Dependent claims 3 to 5 and 9 contain advantageous developments of the solution as claimed in claim 1, whereas advantageous developments of the solution as claimed in claim 2 are specified in dependent claims 6 to 9.

A particularly space-saving overall design of the multiband antennas is possible by means of the embodiment as claimed in claim 3 and 4 and claim 6 and 8.

Claim 5 contains a switchable dual band antenna which is preferably suitable for operation within the frequency ranges of the mobile telephone standards.

The embodiment as claimed in claim 7 has the advantage that the antenna can be produced cost-effectively and essentially in one production step.

Finally, the embodiment as claimed in claim 9 contains a preferred design of the input structures of the antennas, by means of which the latter can be switched reliably and without interference.

The invention will be further described with reference to examples of embodiments shown in the drawings to which, however, the invention is not restricted.

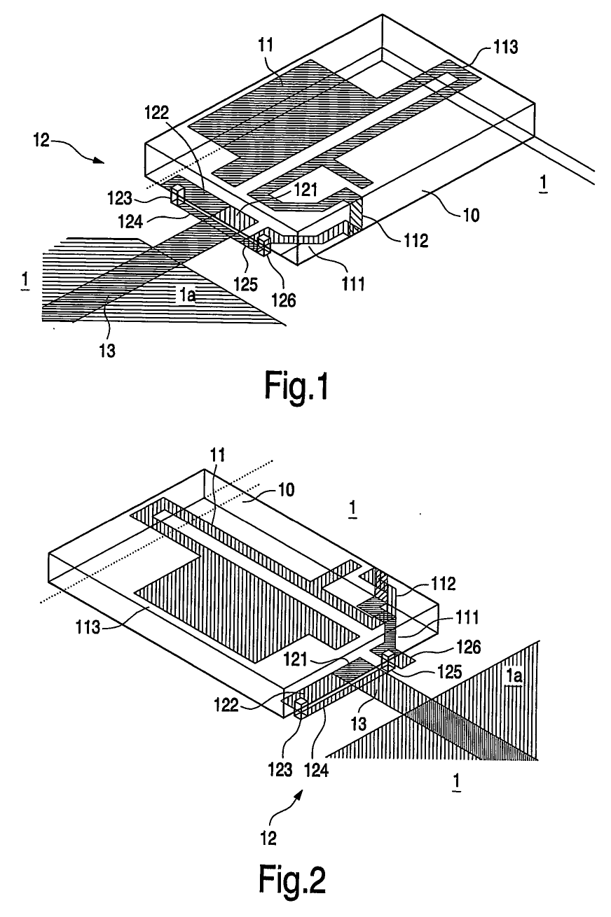

FIG. 1 shows a first perspective view of a first embodiment.

FIG. 2 shows a second perspective view of the first embodiment.

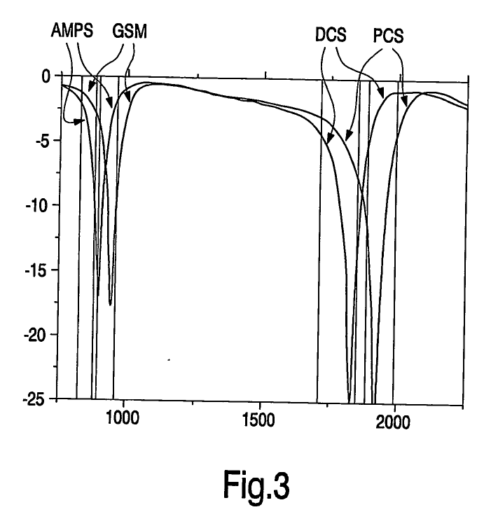

FIG. 3 shows the resonance spectra obtained with the first embodiment of the antenna.

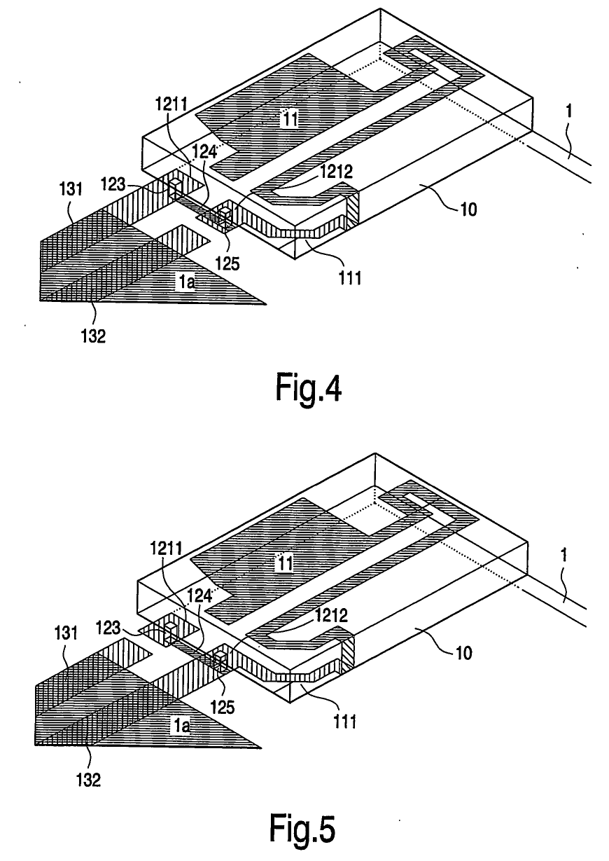

FIG. 4 shows a first perspective view of a second embodiment.

FIG. 5 shows a second perspective view of the second embodiment.

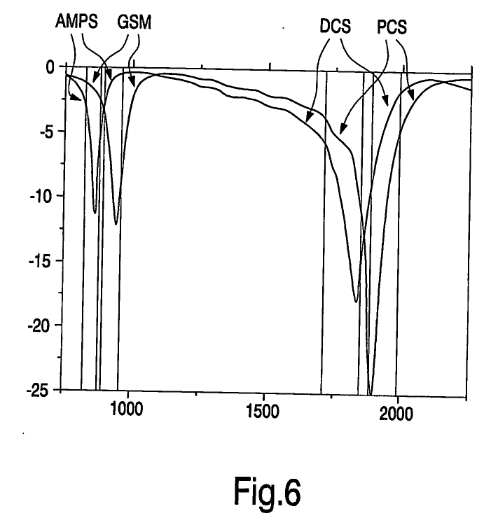

FIG. 6 shows the resonance spectra obtained with the second embodiment of the antenna.

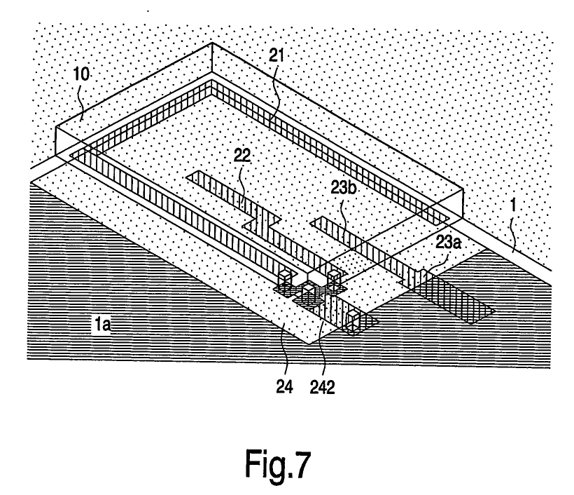

FIG. 7 shows a perspective view of a third embodiment.

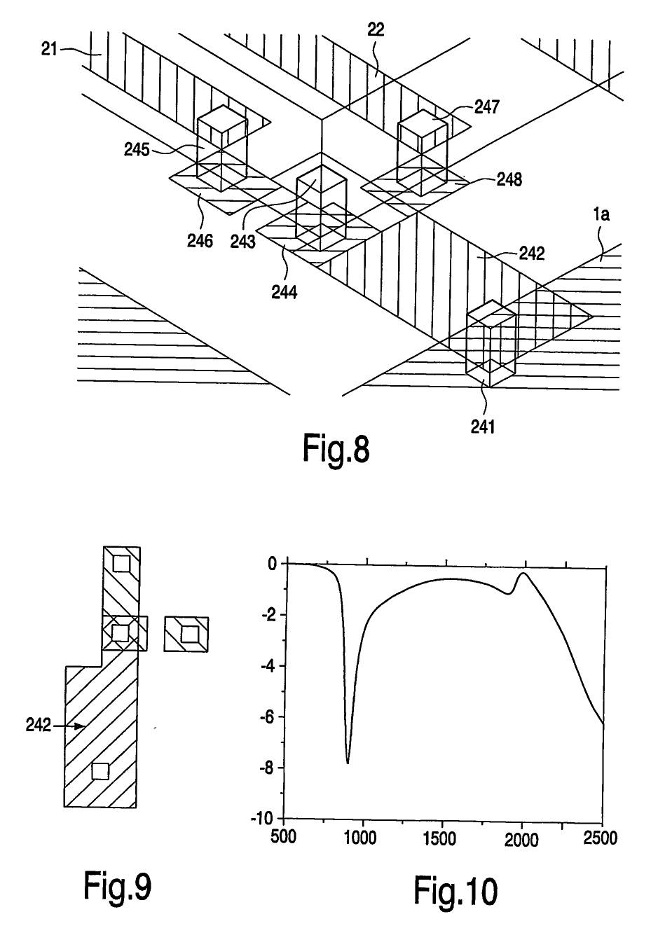

FIG. 8 shows a perspective part-view from FIG. 7.

FIG. 9 shows a first switching position of the antenna shown in FIG. 7.

FIG. 10 shows the resonance spectrum of the antenna obtained with the switching position shown in FIG. 9.

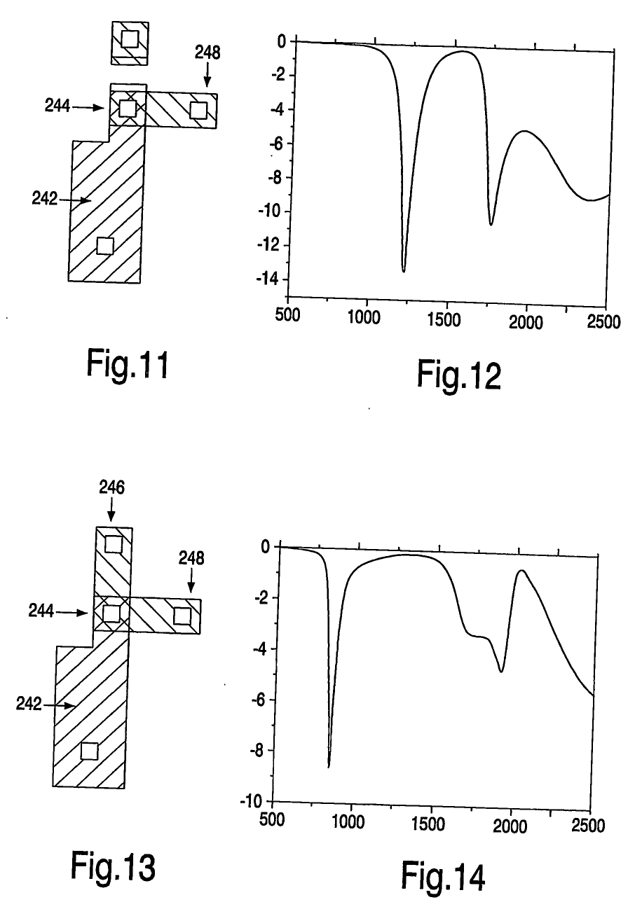

FIG. 11 shows a second switching position of the antenna shown in FIG. 7.

FIG. 12 shows the resonance spectrum of the antenna obtained with the switching position shown in FIG. 11.

FIG. 13 shows a third switching position of the antenna shown in FIG. 7.

FIG. 14 shows the resonance spectrum of the antenna obtained with the switching position shown in FIG. 13.

FIGS. 1 and 2 show perspective views of a first embodiment of a (DBA or PWA) antenna according to the invention which is mounted on the front side of a printed circuit board (PCB) 1, on the rear side of which there is a ground metallization 1a.

The antenna has a substrate 10 in the form of an essentially parallelepiped-shaped block, the length or width of which is about 3 to 40 times greater than its height. In the following description, therefore, the upper (large) face of the substrate 10 will be referred to as the upper main face, the opposite face will be referred to as the lower main face and the faces perpendicular thereto will be referred to as the side faces of the substrate 10.

Instead of a parallelepiped-shaped substrate 10, a different geometric shape such as a round or triangular or polygonal cylinder shape may also be selected, depending on the application and the available space. Furthermore, the substrate 10 may also contain cavities or recesses in order for example to make a saving in terms of material and hence weight.

The substrate 10 is made for example of a ceramic material and/or one or more high-frequency-suitable plastics, or may be made by embedding a ceramic powder in a polymer matrix. Pure polymer substrates may also be used. The materials should exhibit losses that are as low as possible and have a low temperature-dependency of the high-frequency properties (NPO or so-called SL materials).

In order to reduce the size of the antenna, the substrate 10 preferably has a dielectric number of □ᵣ>1 and/or a permeability number of μᵣ>1. However, it should be noted that the achievable bandwidth decreases in the case of substrates with a high or increasing dielectric number and/or permeability number.

In the antenna shown in FIG. 1, the substrate 10 has a length of about 17 mm, a width of about 11 mm and a height of about 2 mm.

The substrate 10 has, essentially on its upper main face, a resonant printed line structure 11 made of a highly electrically conductive material such as, for example, silver, copper, gold, aluminum or a superconductor. The printed line structure 11 could also be embedded in the substrate 10.

In the embodiment shown, the course, the length and the width of the printed line structure 11 are selected by way of example in a manner known per se such that the antenna develops two resonant frequencies (dual band antenna).

The printed line structure 11 is connected via a switchable input structure 12 to an HF line (13) (usually a 50 Ohm line), running on the front side of the printed circuit board 1, for the electromagnetic energy that is to be transmitted and received.

The switchable input structure 12 comprises a feed-in point 121 in the form of a metallization on the lower main face of the substrate 10, which during mounting of the antenna on the printed circuit board is contacted to the HF line 13 for example by soldering.

At the feed-in point 121 there starts a first line section 122 which extends along one side of the substrate 10 in the form of a metallization on the lower main face of the substrate 10. At the end of the first line section 122 there is a first bushing 123 which produces a connection between the first line section 122 and a second line section 124 which is formed by a metallization applied on the rear side of the printed circuit board 1.

This second line section 124 runs essentially parallel to the first line section 122 and ends at a second bushing 125 which connects the second line section 124 to a switch pad 126. The switch pad 126 is applied to the front side of the printed circuit board 1 in the form of a metallization.

During mounting of the antenna on the printed circuit board 1, the start of a first section 111 of the resonant printed line structure 11, located on the lower main face of the substrate 10, is contacted to this switch pad 126.

The switchable input structure 12 finally also comprises a switching device (not shown) which in the closed state connects the switch pad 126 to the feed-in point 121 (or the HF line 13) and in the open state isolates the two from one another.

When the switching device is open (first switching position), the feed-in point 121 is connected to the resonant printed line structure 11 via the first line section 122, the first bushing 123, the second line section 124 and the second bushing 125 which ends at the switch pad 126.

When the switching device is closed (second switching position), the resonant printed line structure 11, which is composed of the first section 111 contacted to the switch pad 126, a second section 112 on a side face of the substrate 10 and a third section 113 applied to the upper main face of the substrate 10, is connected directly to the feed-in point 121 or the HF line 13.

By opening and closing the switching device, it is thus possible for the effective length of the resonant printed line structure 11 to be changed. The extent of this change may be determined in a simple manner by the length of the first and second line sections 122, 124 and the positioning of the first bushing 123.

This switching device may be mounted as an SMD component on the printed circuit board. It may be a conventional high-frequency semiconductor switch, for example a GaAs SPST switch from Macom (operating range between about 0 and 2.5 GHz) or a MEMS (MicroElectroMechanical Switch). It may also be possible for the switching devices to comprise PIN diodes.

FIG. 3 shows, for the antenna shown in FIGS. 1 and 2, the profiles of the reflection parameters S₁₁ [dB] as a function of the frequency [MHz] that are obtained in the two switching positions. The shift in the two resonant frequency ranges can clearly be seen, which ranges lie in the GSM900 and GSM1900/PCS bands in the closed switching position and in the AMPS and GSM/DCS1800 bands when the switching device is open. Where appropriate, higher harmonics of these resonant frequencies may also be used.

A second embodiment of the invention is shown in two perspective views in FIGS. 4 and 5. Identical or similar parts bear the same references as in FIGS. 1 and 2. There is therefore no need for these to be described again, and hence essentially only the differences will be discussed.

In this embodiment, the substrate 10 is made of ceramic material and has a length of about 17 mm, a width of about 11 mm and a height of about 2 mm. It is applied to the front side of a printed circuit board 1, on the rear side of which there is once again a ground metallization 1a.

By contrast to the first embodiment, in the second embodiment the switchable input structure 12 has a first and a second feed-in point 1211, 1212 for the antenna. The first feed-in point 1211 is connected via a first bushing 123 to a line section 124 that runs on the rear side of the printed circuit board 1. At the end of this line section 124 there is a second bushing 125 which produces a connection to the second feed-in point 1212. During mounting of the antenna, the second feed-in point 1212 is contacted to one end of the first section 111 of the resonant printed line structure 11, located on the lower main face.

In correspondence with the two feed-in points 1211, 1212, a first HF line 131 and a second HF line 132 are arranged on the front side of the printed circuit board 1. These two lines 131, 132 are alternatively connected to the first and second feed-in points 1211, 1212, respectively, for example by means of one of the above-described switching devices (not shown) or a suitable switch.

FIG. 4 shows a first switching position in which such a switching device connects the first HF line 131 to the first feed-in point 1211 and isolates the second HF line 132 from the second feed-in point 1212. FIG. 5 shows a second, opposite, switching position in which the second HF line 132 is connected to the second feed-in point 1212 and the first HF line 131 is isolated from the first feed-in point 1211.

By selecting the switching positions, it is in turn possible to change the effective length of the resonant printed line structure 11. The extent of this change may be determined by the distance of the two feed-in points 1211, 1212 from one another.

FIG. 6 shows, for the antenna shown in FIGS. 4 and 5, the profiles of the reflection parameters S₁₁ [dB] as a function of the frequency [MHz] that are obtained in the two switching positions. In this diagram too, it is possible to clearly see the shift in the two resonant frequency ranges, which lie in the AMPS and GSM/DCS1800 bands in the case of the switching position shown in FIG. 4 and in the GSM900 and GSM1900/PCS bands in the case of the switching position shown in FIG. 5.

The first and second embodiments of the invention are thus particularly suitable for use in mobile telephones which are to be used both in Europe and in the USA. Corresponding control signals which are used to switch the input structures can be derived from the mobile radio systems.

FIG. 7 shows a third embodiment of the antenna according to the invention.

The antenna once again has a preferably ceramic substrate 10 of the type mentioned above, having a length of about 20 mm, a width of about 12 mm and a height of about 2 mm.

The substrate 10 has, on its lower main surface, a first resonant printed line structure 21 and a second resonant printed line structure 22. Since the printed line structures 21, 22 are located on just one main face, cost-effective production of the antenna in one production step and a reduction of the height to less than about 2 mm without a loss in power are possible. The substrate 10 is mounted on the front side of a printed circuit board 1 which on its rear side has a ground metallization 1a.

On the front side of the printed circuit board there is an BF line 23a which extends through to underneath the substrate 10 as a feed line 23b, so that electromagnetic energy can be capacitively coupled into the antenna and out of the latter.

The two resonant printed line structures 21, 22 may be connected via a switchable input structure 24 to the ground metallization la on the rear side of the printed circuit board 1.

This input structure 24 is shown in detail in FIG. 8. It comprises a first bushing 241 through the printed circuit board 1, which bushing connects the ground metallization 1a on the rear side of the printed circuit board 1 to a ground line 242 on the front side of the printed circuit board 1. This ground line 242 extends through to underneath the substrate 10 and ends at a second bushing 243 which connects said ground line to a first switch pad 244 applied on the rear side of the printed circuit board 1.

A second bushing 245 connects one end of the first resonant printed line structure 21 to a second switch pad 246 on the rear side of the printed circuit board 1. Finally, there is provided a third bushing 247 which connects one end of the second resonant printed line structure 22 to a third switch pad 248 on the rear side of the printed circuit board 1. The three switch pads 244, 246, 248 preferably have dimensions of about 1×1×1 mm and are made of copper.

Depending on the number and position of the desired resonant frequency bands in which the antenna is to be operated, even more resonant printed line structures may be applied to the substrate 10 and be connected by one of their ends, via a bushing, to a corresponding switch pad on the rear side of the printed circuit board 1.

The input structure 24 furthermore comprises one or more switching devices (not shown) by means of which the first switch pad 244 can be connected to the second switch pad 246 and/or to the third switch pad 248. The switching device(s) is (are) preferably designed as mentioned above and can be switched such that either the first resonant printed line structure 21 or the second resonant printed line structure 22 or possibly even both printed line structures 21, 22 can be connected to the ground metallization or isolated therefrom, independently of one another, depending on the desired operating frequency ranges.

Apart from the fact that this makes it possible for a larger number of frequency bands to be covered by one antenna, there is also the advantage that the printed line structure activated by closing the relevant switching device is not influenced or adversely affected in terms of its performance by the (at least one) other printed line structure, provided that the latter is isolated from the ground metallization la by opening the relevant switching device. Furthermore, the printed line structures 21, 22 can be dimensioned and optimized, in terms of the resonant frequency range provided, independently of one another. This results in a greater spectrum of use of the antenna in comparison with known antennas of this type comprising two or more resonant printed line structures.

FIG. 9 schematically shows, in plan view, a first switching position of the switching device, in which the ground line 242 is connected to the first resonant printed line structure 21 via the first and second switch pads 244, 246.

FIG. 10 shows the resulting resonance spectrum in the form of the profile of the reflection parameter S₁₁ [dB] as a function of the frequency [MHz]. The pronounced resonance in the GSM900 frequency band can clearly be seen. At the same time, the first harmonic of this resonance is highly suppressed, so that the requirements placed on the diplexer of the system are relatively low compared to known antennas of this type since in this case a first harmonic that is adapted as well as possible is required for multiband operation.

FIG. 11 schematically shows, in plan view, the case in which, in a second switching position of the switching device, the ground line 242 is connected to the second resonant printed line structure 22 via the first and third switch pads 244, 248.

FIG. 12 shows the resulting resonance spectrum once again in the form of the profile of the reflection parameter S₁₁ [dB] as a function of the frequency [MHz]. In this case, the resonance in the GSM900 frequency band is no longer present. Rather, a highly broadband dual resonance between about 1700 MHz and about 2500 MHz develops, which allows operation of the antenna in the DCS, PCS, UMTS and BT frequency bands.

Finally, FIG. 13 schematically shows the case in which, in a third switching position of the switching device, the ground line 242 is connected both to the first and to the second resonant printed line structures 21, 22 via the first and second and also via the first and third switch pads 244, 246; 244, 248.

The resulting resonance spectrum is shown in FIG. 14, once again in the form of the profile of the reflection parameter S₁₁ [dB] as a function of the frequency [MHz]. In this case, the lowest resonant frequency is about 850 MHz, so that the antenna can also be operated in the AMPS frequency band.

1. A switchable multiband antenna for the high-frequency and microwave range, comprising at least one resonant printed line structure (11) which is applied to a substrate (10), and comprising a switchable input structure (12) and at least one line section (122, 124) that is arranged on a support (1) of the substrate (10), wherein the switchable input structure (12) is provided to connect at least one HF line (13; 131, 132) or at least one ground line to the resonant printed line structure (11) by optional interconnection or bridging of the at least one line section (122, 124) by switching the input structure (12).

2. A switchable multiband antenna for the high-frequency and microwave range, comprising at least two resonant printed line structures (21, 22) which are applied to a substrate (10), and comprising a switchable input structure (24) for the optional connection of an HF line (23) or a ground line (242) to at least one of the resonant printed line structures (21, 22).

3. A switchable multiband antenna as claimed in claim 1, wherein the support is a printed circuit board (1) and at least one of the line sections (122, 124) is arranged on the rear side of the printed circuit board (1) which lies opposite the substrate (10).

4. A switchable multiband antenna as claimed in claim 3, wherein the switchable input structure (12) comprises a feed-in point (121) which in a first switching position can be connected to the resonant printed line structure (11) via a first line section (122), a first bushing (123) through the printed circuit board (1), a second line section (124) and a second bushing (125) through the printed circuit board (1), and in a second switching position can be connected directly to the resonant printed line structure (11).

5. A switchable multiband antenna as claimed in claim 1, wherein two HF lines (131, 132) are provided, which can be connected alternatively to a first and a second end of one of the line sections (122, 124) by means of the input structure (12).

6. A switchable multiband antenna as claimed in claim 2, wherein the substrate (10) is arranged on one side of a support (1) and the switchable input structure (24) is arranged on the opposite side of the support (1).

7. A switchable multiband antenna as claimed in claim 6, wherein the resonant printed line structures (21, 22) are applied to the side of the substrate (10) which bears against the support (1), with the printed line structures (21, 22) being connected to the switchable input structure (24) via bushings (245, 247).

8. A switchable multiband antenna as claimed in claim 7, wherein the input structure (24) comprises in each case one switch pad (246, 248) which is connected to each bushing (245, 247) and can be connected to the HF line (23) or ground line (242) by switching the input structure (24).

9. A switchable multiband antenna as claimed in claim 1, wherein the input structure (12; 24) comprises, for switching purposes, semiconductor switches or microelectromechanical switches (MEMSs).

10. A mobile telecommunications device comprising a support (1) and a switchable multiband antenna as claimed in claim 1.
